(19) United States
(12) Patent Application Publication
(10) Pub. No.: US 2006/0187405 A1
(43) Pub. Date: Aug. 24, 2006

(54) Assembly of sunshade clip and spectacles using nose pad means

(76) Inventors: Suk-Jae Lee, Daegu (KR); Ju-Jae Lee, Daegu (KR); Hyun-Jun Lee, Daegu (KR)

Correspondence Address: MAYER, BROWN, ROWE & MAW LLP, 1909 K STREET, N.W., WASHINGTON, DC, 20006, US

(21) Appl. No.: 11/060,732

(22) Filed: Feb. 18, 2005

(51) Int. Cl. G02C 9/00

(52) U.S. Cl. 351/47

(57) ABSTRACT

Disclosed herein is an assembly of a sunshade clip and spectacles using nose-pad means. The spectacles comprise a pair of lens frames connected to each other by means of a bridge, a pair of temple arms connected to the respective lens frames by means of a pair of magnetically-induced hinges, and a pair of magnets inserted in the nose-pad means of the spectacles. The sunshade clip comprises a pair of sunshade lenses connected to each other by means of a sunshade bridge, a pair of sunshade magnet arms mounted on or below the sunshade bridge to extend toward the nose-pad means of the spectacles. Each of the magnet arms has a magnet inserted in an end region thereof. In this way, the sunshade clip is detachably attached to the spectacles by making use of magnetic force of their magnets.

### BACKGROUND OF THE INVENTION

### Field of the Invention

The present invention relates to an assembly of a sunshade clip and spectacles using nose-pad means, and more particularly to nose-pad means of a sunshade clip and spectacles, which have magnets for detachably attaching the sunshade clip, serving as sunglasses, to the spectacles.

### SUMMARY OF THE INVENTION

It is an object of the present invention to provide an assembly of a sunshade clip and spectacles using nose-pad means in which magnets provided in the nose-pad means can serve to detachably attach the sunshade clip to the spectacles, thereby being capable of achieving a weight reduction of the assembly due to the use of the small and light magnets, and minimizing the number of elements, resulting in an improved aesthetic value of products.

It is another object of the present invention to provide an assembly of a sunshade clip and spectacles using nose-pad means which can achieve a weight reduction thereof through weight reduction of existing elements of the spectacles, and can ensure easy and simple attachment of the sunshade clip to the spectacles.

It is yet another object of the present invention to provide an assembly of a sunshade clip and spectacles using nose-pad means wherein the sunshade clip can be simply attached to or detached from the spectacles using magnetic force of the nose-pad means formed by utilizing existing elements of the spectacles, resulting in a maximized use and wearing convenience.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a rear perspective view illustrating an assembled state of a sunshade clip and spectacles using nose-pad means in accordance with a first embodiment of the present invention;

FIG. 2 is an exploded rear perspective view of the sunshade clip and spectacles shown in FIG. 1, the important parts of the sunshade clip and the spectacles being shown in enlarged circles;

FIG. 3 is an exploded rear perspective view illustrating an alternative embodiment of FIG. 2, the important parts being shown in enlarged circles;

FIG. 4 is a partially broken away rear perspective view illustrating nose-pad means of the spectacles in accordance with a second embodiment of the present invention, the important part thereof being shown in an enlarged circle;

FIG. 5 is a partially broken away rear perspective view illustrating nose-pad means of the spectacles in accordance with a third embodiment of the present invention, the important part thereof being shown in an enlarged circle;

FIG. 6 is a partially broken away rear perspective view illustrating nose-pad means of the spectacles in accordance with a fourth embodiment of the present invention, the important part thereof being shown in an enlarged circle;

FIG. 7 is a partially broken away rear perspective view illustrating nose-pad means of the spectacles in accordance with a fifth embodiment of the present invention, the important part thereof being shown in an enlarged circle; and

FIG. 8 is a partially broken away rear perspective view illustrating nose-pad means of the spectacles in accordance with a sixth embodiment of the present invention, the important part thereof being shown in an enlarged circle;

### DESCRIPTION OF THE PREFERRED EMBODIMENTS

Now, the configuration and operational effects of the present invention will be explained in relation to the preferred embodiments with reference to the accompanying drawings.

It will be clearly understood that the present invention is applicable to various kinds of spectacles having different shapes and made of various materials without being limited to the accompanying drawings. That is, the present invention can be widely applied on the assumption that the spectacles have nose-pads. Hereinafter, since left and right sides of the spectacles are symmetrical, only one side will be explained.

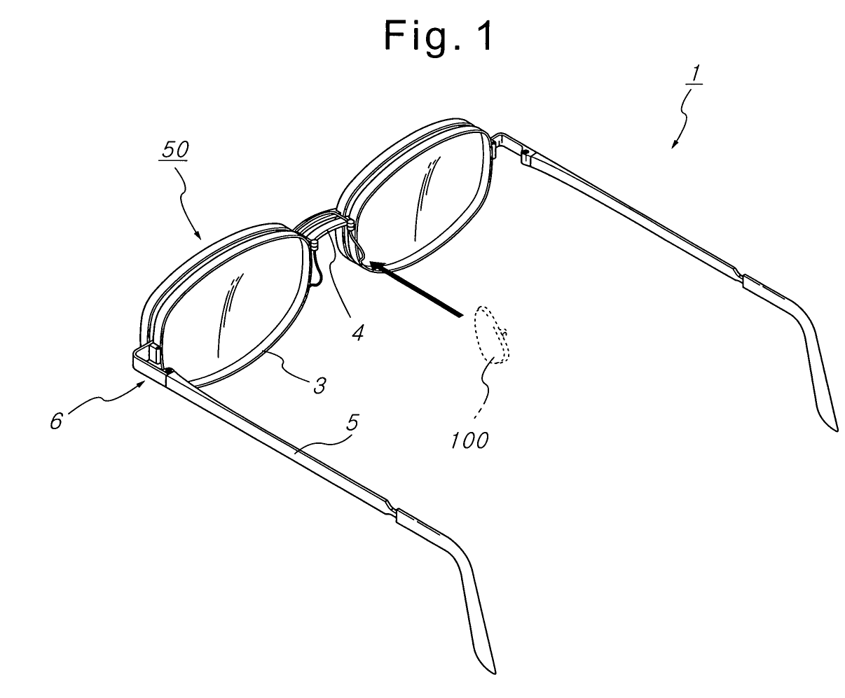

Referring to FIG. 1 illustrating an assembled state of a sunshade clip 50 and spectacles 1 in accordance with a first embodiment of the present invention, the spectacles comprises a pair of lens frames 3, a nose bridge 4 for connecting the lens frames 3 to each other, a pair of temple arms 5, and a pair of hinges 6 each for connecting a respective one of the lens frames 3 to a respective one of the temple arms 6. In the present embodiment, the spectacles 1 are metal-rimmed spectacles, and thus the respective elements 3, 4, 5 and 6 are made of metal.

The spectacles 1 also comprise a pair of nose-pads 100 (shown by dotted line). The nose-pads 100 are conventionally made of soft or hard synthetic resin material, and are bolted to nose-pad connectors (not shown) fixed at the respective lens frames 3.

The present invention features that the nose-pads 100 are modified to have a function of detachably attaching the sunshade clip 50 to the spectacles 1 by means of magnets.

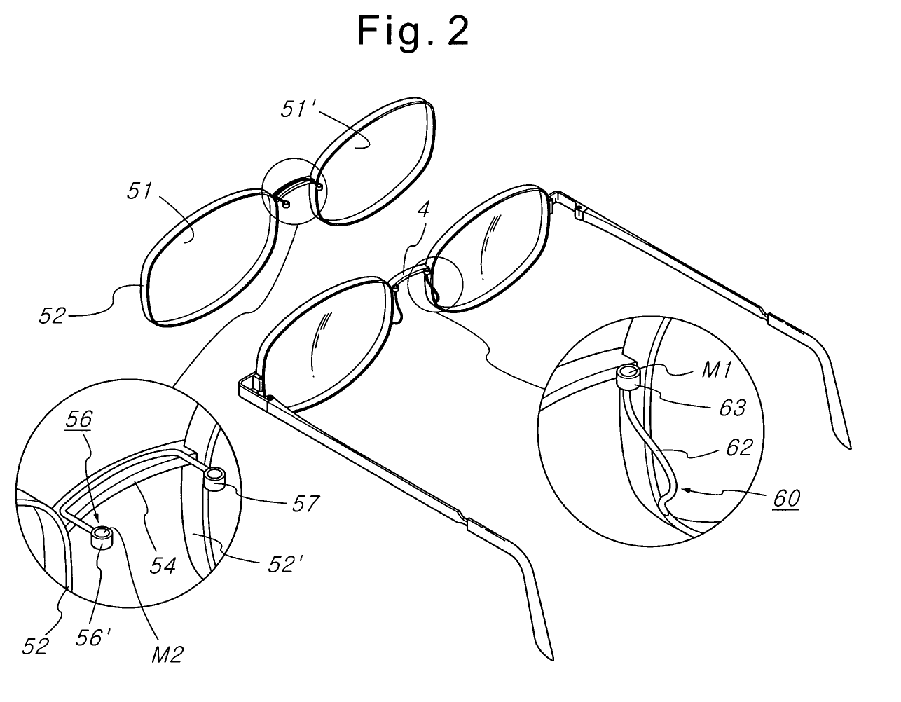

Referring to FIG. 2, the present invention provides the spectacles 1 with a pair of magnet arms 60 instead of the conventional nose frames 100. The magnet arms 60 are formed by bending metal wires into a desired form suitable to have the function of a nose-pad. Hereinafter, since the magnet arms 60 are symmetrical, only one magnet arm 60 will be explained.

The magnet arm 60 is divided into a nose-pad element 62 and a magnet mounting element 63. The nose-pad element 62 is welded at a lower end thereof to a predetermined position below the center of the lens frame 3, and an upper end of the nose-pad element 62 is spaced apart from the lens frame 3 to form a free end. Such a nose-pad element 62 centrally bends to protrude toward the wearer's nose in order to perform the function of the conventional nose-pad. To the free upper end of the nose-pad element 62 is integrally welded the magnet mounting element 63. The magnet mounting element 63 is a short tubular member having a ring form to fixedly receive a magnet M1 therein. The magnet M1 has a shape selected from among various shapes, such as rod and disk shapes.

As stated above, the magnet arm 60, which can be used as a conventional nose-pad and magnet receiving means, are mounted to inner ends of the left and right lens frames 3.

The sunshade clip 50 basically comprises a pair of colored sunshade lenses 51 and 51′ serving as sunglasses, a pair of sunshade lens frames 52 and 52′, and a sunshade bridge 54 for connecting the sunshade lens frames 52 and 52′ to each other.

In the present embodiment, as shown in FIG. 2, the sunshade clip 50 further comprises a pair of sunshade magnet arms 56 and 57, which are installed on the sunshade bridge 54 to extend toward the wearer's nose by a predetermined length, so that they are positioned to correspond to the magnets M1 of the magnet arms 60 provided at the spectacles 1. Since the sunshade magnet arms 56 and 57 are symmetrical, only one sunshade magnet arm 56 will be explained hereinafter.

The sunshade magnet arm 56 has a ring-shaped magnet mounting element 56′ welded at a free end thereof, and inside the magnet mounting element 56′ is fixedly inserted a sunshade magnet M2.

Although the sunshade magnet arm 56 is shown as a U-shaped single member in FIG. 2, it should be understood that the sunshade magnet arm may be divided into a pair of separated symmetrical members 56 and 57 as described above.

For the attachment of the sunshade clip 50 and the spectacles 1 configured as stated above, the sunshade clip 50 is aligned relative to the spectacles 1 so that the sunshade magnets M2 received in the sunshade magnet arms 56 and 57 of the sunshade clip 50 are correspondingly positioned on the magnets M1 received in the magnet arms 60 of the spectacles 1. In such an aligned state, the sunshade clip 50 is securely fixed to the spectacles 1 by magnetic force of the magnets M1 and M2. Such a sunshade clip 50 functions sunglasses.

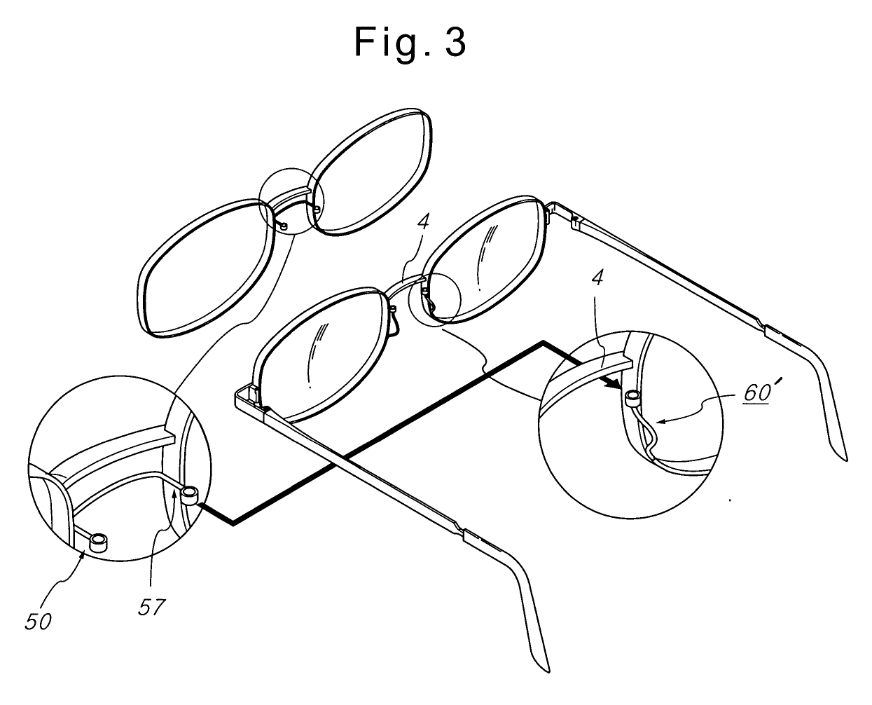

Referring to FIG. 3 illustrating an alternative embodiment of FIGS. 1 and 2, the spectacles 1 are provided with magnet arms 60′, which have the same shape as the magnet arms 60 of the first embodiment, but are shorter than the magnet arms 60. When the shorter magnet arms 60′ are mounted to the lens frames 3 of the spectacles 1, the sunshade magnet arms 56 and 57 of the sunshade clip 1 have to be positioned below the sunshade bridge 54 so as to be correspondingly lowered in height. In such an alternative embodiment, the sunshade magnet arms 56 and 57 are accessible below the bridge 4 of the spectacles so as to be detachably coupled to the magnet arms 60′.

On the basis of the sunshade magnet arms 56 and 57 and the sunshade magnets M2 of the sunshade clip 50 as stated above, various equivalent modifications and adjustments of the magnets arms 60, namely, the nose-pad means of the spectacles 1 will be achieved and some examples thereof will now be explained.

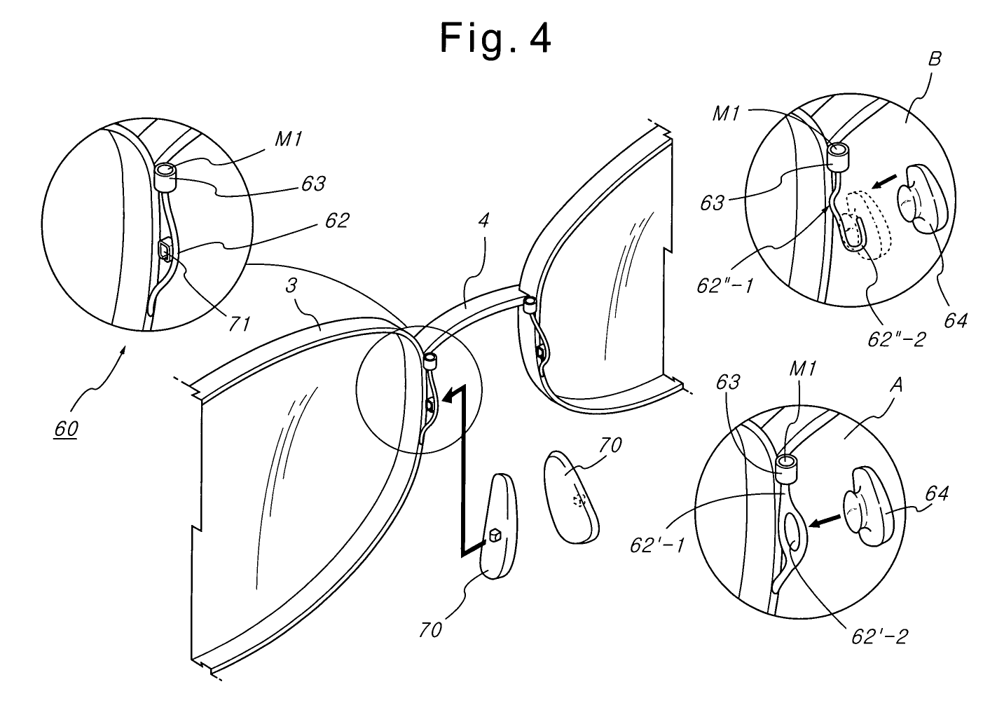

FIG. 4 illustrates nose-pad means of spectacles in accordance with a second embodiment of the present invention. As shown in FIG. 4, the nose-pad means of the present embodiment comprises a pair of magnet arms 60″ each comprising a nose-pad 70 and a bolt box 71, in addition to the nose-pad element 62 and the magnet mounting element 63 of the first embodiment. The bolt box 71 is welded to the center of the nose-pad element 62, and in turn, the nose-pad 70 is bolted to the bolt box 71. As one would expect, the nose-pad element 62, formed by bending a wire, tends to cause pain or leave a mark on the wearer's nose. The nose-pad 70 of the present embodiment enables more stabilized wearing of the spectacles 1 as compared to the sole use of the bent rod-shaped nose-pad element 62.

Another embodiment having the same technical idea is presented on the circular part A of FIG. 4. In this embodiment, the nose-pad element 62′-1 is consisted of a formed shape having nose-pad hole 62′-2 and nose-pad 64 made of rubber, silicon rubber etc. This embodiment will provide more comfortable contacts with human noses. Other possible embodiment is presented on the circular part B. This embodiment shows nose-pad element can be susbstituted by the prior wire nose-pad arm 62″-1 and pad hodler 62″-2 for nsoe-pad 64.

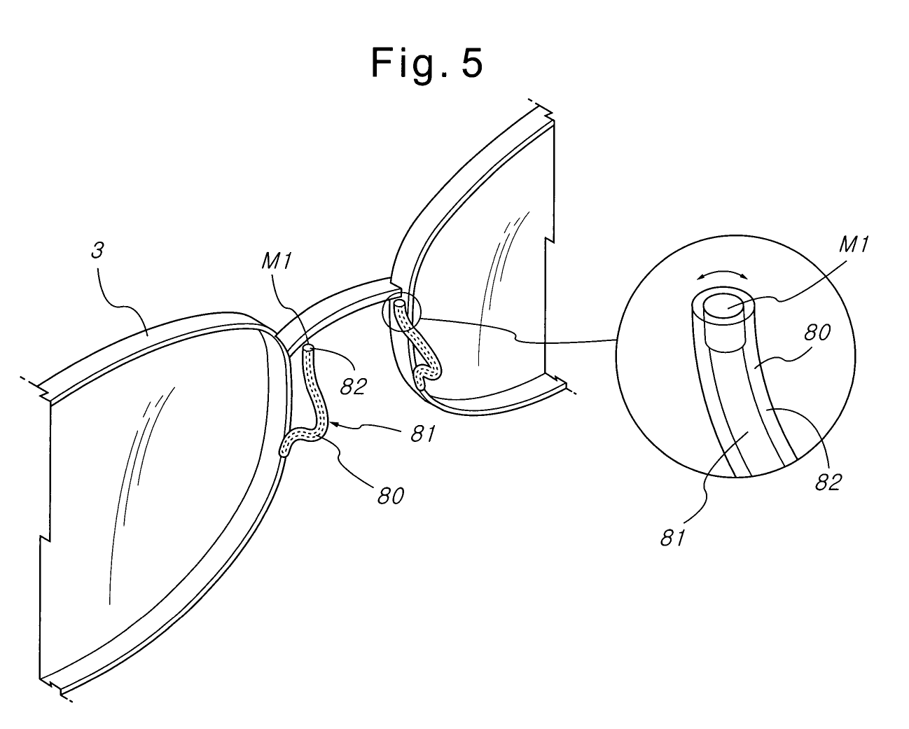

FIG. 5 illustrates nose-pad means of spectacles in accordance with a third embodiment of the present invention. As shown in FIG. 5, the nose-pad means of the present embodiment comprises a magnet arm 81, which is reinforced in elasticity as compared to the magnet arm 60 of the first embodiment shown in FIG. 2, in order to achieve more convenient wear of the spectacles. For this, the magnet arm 80 of the present embodiment comprises a pair of nose-pad elements 81, around which soft tubular members 81 are wrapped, respectively. The soft tubular member 82 serves to reduce or eliminate pain or marks left on the wearer's nose even in the case of long term use. In this case, the magnet M1 is inserted into one end of the soft tubular member 82 in a freely movable state, for ensuring accurate and easy fixation of the sunshade clip 50.

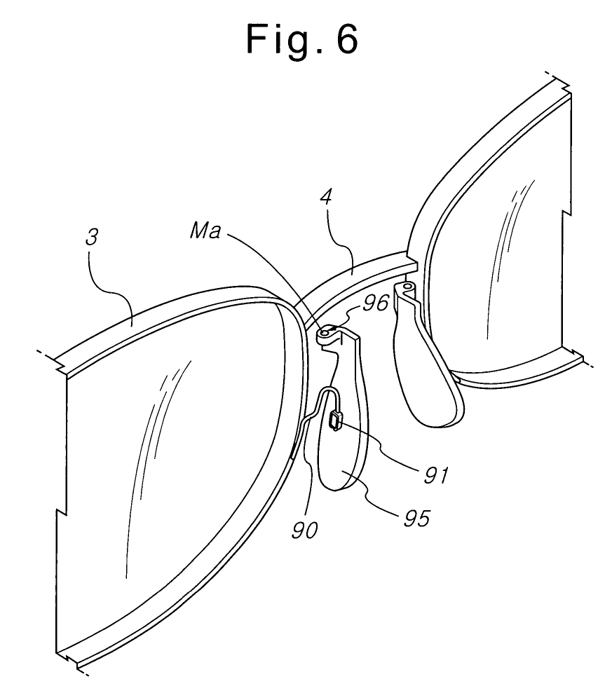

FIG. 6 illustrates nose-pad means of spectacles in accordance with a fourth embodiment of the present invention. As shown in FIG. 6, the nose-pad means of the present embodiment comprises a nose-pad arm 90 welded at a lower end thereof to a respective one of the lens frames 3, and a bolt box 91 fixed at a free upper end of the nose-pad arm 90 to fix a nose-pad 95, and a magnet mounting element 96 integrally formed at an upper end of the nose pad 95 by injection molding. A magnet Ma, inserted in the magnet mounting element 96, effects the same function as those of the first to third embodiments.

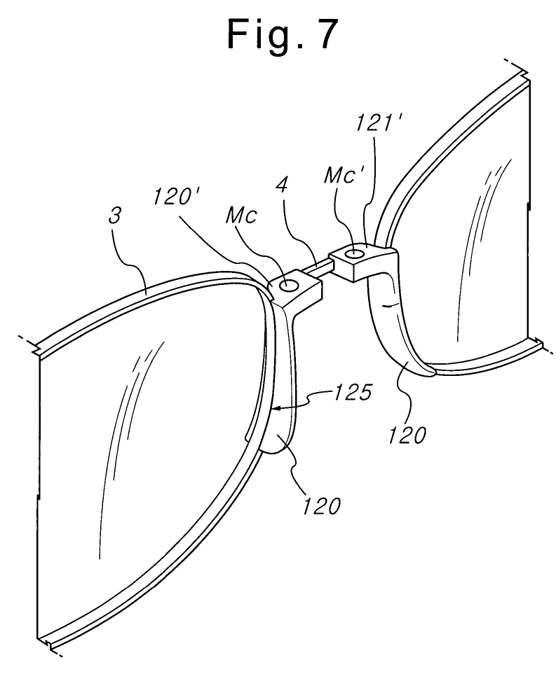

FIG. 7 illustrates nose-pad means of spectacles in accordance with a fifth embodiment of the present invention. As shown in FIG. 7, the nose-pad means of the present embodiment comprises a pair of nose-pads 120 and 121 coupled to the bridge 4. The nose-pads 120 and 121 are coupled to the respective lens frames 3 as their nose connector portions are inserted through fitting slits 125 formed along a predetermined length of the inner ends of the lens frames 3. In this case, the nose-pads 120 and 121 may be integrally molded with the bridge 4 or may be attached thereto using an adhesive. At upper ends of the nose-pads 120 and 121 are formed respective magnet mounting portions 120′ and 121′ for receiving magnets Mc and Mc′.

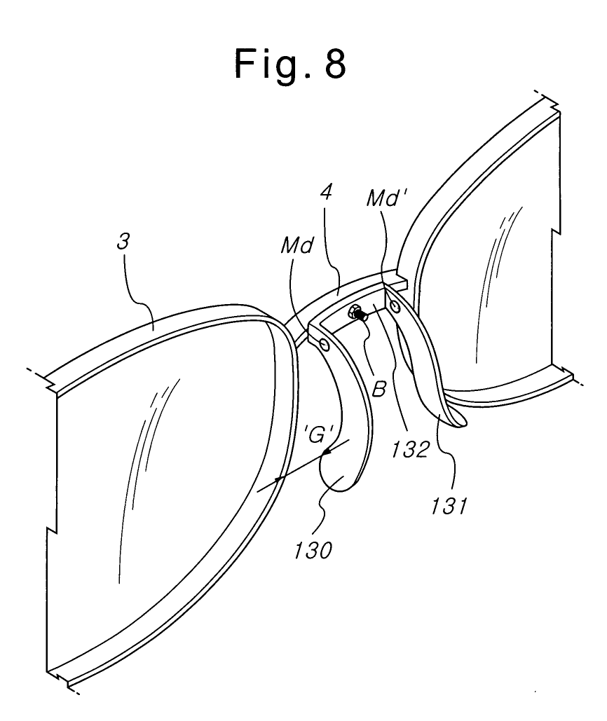

FIG. 8 illustrates nose-pad means of spectacles in accordance with a six embodiment of the present invention. As shown in FIG. 8, the nose-pad means of the present embodiment comprises a nose-pad unit fastened to the center of the bridge 4 by means of a bolt B. The nose-pad unit has an approximately U-shaped form consisting of a pair of nose-pads 130 and 131 and a pad connector 132 therebetween. In a state wherein the pad connector 132 is bolted to the bridge 4 of the spectacles, the nose-pads 130 and 131 are spaced apart from the lens frames 3 by a predetermined gap G, and magnets Md and Md′ are inserted in holes formed at upper ends of the nose-pads 130 and 131.

It should be understood that the sunshade magnet arms 56 and 57 and the sunshade magnets M2 of the sunshade clip 50 are deformable to conform to the above described first to sixth embodiments.

As apparent from the above description, the present invention provides an assembly of a sunshade clip and spectacles using nose-pad means, which can reduce the number of elements required to attach the sunshade clip to the spectacles through modification of existing nose-pads, resulting in an improved aesthetic value of products.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An assembly of a sunshade clip and spectacles, the sunshade clip being attachable to the spectacles by means of nose-pad means,
wherein the spectacles comprise:
a pair of lens frames connected to each other by means of a bridge;
a pair of temple arms connected to the respective lens frames by means of a pair of magnetically-induced hinges; and
a pair of magnets inserted in the nose-pad means of the spectacles, and
wherein the sunshade clip comprises:
a pair of sunshade lenses connected to each other by means of a sunshade bridge;
a pair of sunshade magnet arms mounted on or below the sunshade bridge to extend toward the nose-pad means of the spectacles, each of the magnet arms having a magnet inserted in an end region thereof,
whereby the sunshade clip is detachably attached to the spectacles by making use of magnetic force of their magnets.

2. The assembly as set forth in claim 1, wherein the nose-pad means of the spectacles includes a pair of magnet arms formed by bending wires, and
wherein each of the magnet arms has:
a nose-pad element welded at a lower end thereof to a predetermined position below the center of an associated one of the lens frames and centrally bending to protrude toward the wearer's nose, an upper end of the nose-pad element forming a free end; and
a magnet mounting element welded to the free upper end of the nose-pad element and adapted to fixedly receive a magnet.

3. The assembly as set forth in claim 2, wherein the magnet arm is sized so that the magnet mounting element thereof is positioned below the bridge of the spectacles, and correspondingly the sunshade magnet arms of the sunshade clip are positioned below the sunshade bridge of the sunshade clip so as to be lowered in height,
whereby the sunshade magnet arms are accessible below the bridge of the spectacles.

4. The assembly as set forth in claim 1, wherein the nose-pad means of the spectacles includes a pair of magnet arms, and
wherein each of the magnet arms has:
a nose-pad element provided at an upper end thereof with a magnet mounting element;
a bolt box welded to the center of the nose-pad element; and
a nose-pad bolted to the bolt box.

5. The assembly as set forth in claim 1, wherein the nose-pad means of the spectacles includes a pair of nose-pad units, and
wherein each of the nose-pad units has:
a center nose-pad element; and
a tubular member made of a soft material and configured to wrap the nose-pad element to provide the nose-pad element with elasticity.

6. The assembly as set forth in claim 1, wherein the nose-pad means of the spectacles includes a pair of nose-pad units, and
wherein each of the nose-pad units has:
a nose-pad arm fixed at a lower end thereof to a respective one of the lens frames;
a bolt box mounted at a free upper end of the nose-pad arm;
a nose-pad bolted to the bolt box; and
a magnet mounting element formed at an upper end of the nose pad to receive a magnet Ma.

7. The assembly as set forth in claim 1, wherein the nose pad means of the spectacles includes a pair of nose-pad units, and
wherein each of the nose-pad units has:
a nose-pad coupled to the bridge so as to be coupled to a respective one of the lens frames as a nose connector portion thereof is inserted through a fitting slit formed along a predetermined length of an inner end of the lens frame; and
a magnet mounting portion formed at an upper end of the nose-pad for receiving a magnet.

8. The assembly as set forth in claim 1, wherein the nose pad means of the spectacles includes an approximately U-shaped nose-pad unit bolted to the bridge of the spectacles,
wherein the U-shaped nose-pad unit has:
a pair of nose-pads spaced apart from the lens frames by a predetermined gap;
a pad connector integrally formed with the nose-pads to connect them; and
magnets inserted in holes formed at upper ends of the nose-pads.
